(19) United States
(12) Patent Application Publication
(10) Pub. No.: US 2010/0226772 A1
(43) Pub. Date: Sep. 9, 2010

(54) Blade control system

(76) Inventor: Kenneth James Deering, Seattle, WA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/660,914

(22) Filed: Mar. 5, 2010

(30) Foreign Application Priority Data
Feb. 25, 2009 (AU) 2009 900827
Feb. 25, 2009 (AU) 2009 900828
Feb. 25, 2009 (AU) 2009 900830
Feb. 25, 2009 (AU) 2009 900831
Feb. 25, 2009 (AU) 2009 900832

(51) Int. Cl. F03D 7/02

(52) U.S. Cl. 416/1; 416/9

(57) ABSTRACT

A wind turbine system for blade control which employs means for adjusting the pitch and yaw of the blades rotating about an axis and the resulting speed of the blades powering a wind turbine. The control system selectively resists movement of said blades to a different incline position based on a comparison of the measured rotational speed with a target speed value, the target speed value being determined based on an energy output level for said turbine. The control system includes at least one adjustable hydraulic actuator for movement of said blades to a different incline position.

### FIELD OF THE INVENTION

This application claims priority to Australian Provisional Patent Number 2009 900828 filed Feb. 25, 2009, and Australian Provisional Patent Number 2009 900827 filed Feb. 25, 2009, and Australian Provisional Patent Number 2009 900831 filed Feb. 25, 2009, and Australian Provisional Patent Number 2009 900830 filed Feb. 25, 2009, and Australian Provisional Patent Number 2009 900832 filed Feb. 25, 2009, each of which is respectively incorporated herein in its entirety by reference.

The present invention relates to systems and methods for turbine blade control. More particularly it relates to such a system for blade control which employs means for adjusting the pitch and yaw of the blades rotating about an axis and the resulting speed of the blades powering a wind turbine.

### BACKGROUND OF THE INVENTION

A typical wind turbine includes a rotor with multiple blades. When the blades are exposed to a sufficient level of airflow, aerodynamic forces created by the blades cause the rotor to rotate about an axis. To enhance the rotor's exposure to airflow, the rotor may be elevated to a certain height above ground by a support structure (e.g. a tower.) The rotational energy of the rotor can be harnessed in many ways, for example, to produce electricity. In order for the energy captured by the rotor to be harnessed efficiently, the rotor needs to be able to rotate both under low wind speed and high wind speed conditions.

As the direction of wind changes over time, the rotor's rotational axis may no longer be optimally aligned to (e.g. substantially in parallel to) the direction of the wind, which gives rise to yaw error. When this occurs, a smaller area of the blades will be exposed to the wind. The blades, therefore, capture less energy from the wind, and may cause the rotational speed of the rotor to slow down. Yaw error gives rise to different forces acting on the rotor. Parts of the blades located closer towards the direction of the incoming wind will tend to yaw against the wind while the force of the wind acting on the rotor tends to bend the blades in a downwind direction. A rotor with yaw error can therefore expose its blades to greater fatigue loads. If such loads are not properly controlled or averted, damage may arise to the rotor or structure of the wind turbine.

Several methods have been proposed to help regulate the rotational speed of a rotor. One method for regulating power output from a wind turbine operating in high wind speed conditions (i.e. wind speed in excess of that required to produce rated power), is to adjust the pitch position of the blades. This involves continuously reading the generator power output of the wind turbine and comparing the power output with a target power value (i.e. the rated power of the turbine). A pitch position or pitch rate command can then be derived, using a control computer, from the magnitude of difference between the actual generator power output and the target power. The pitch position or pitch rate command issued to the blade pitch actuators is the same for all blades, which can be referred to as a collective pitch command.

Another control method employs the concept of varying yaw position. There have been various attempts at controlling the yaw position of a wind turbine's rotors. One approach involves using a yaw control motor to rotate a worm gear, which in turn, drives a wind turbine rotor to rotate to a different yaw position. However, with this approach the rotor is retained in a fixed yaw position in the absence of power to the yaw control motor. Another yaw control approach involves using a drive component (comprising a motor and gears) and a large spring-applied brake. The brake resists rotation of the gears to resist adjustment to a yaw position of the rotor. The brake is retracted when power is applied to the motor which drives the gears to rotate the rotor to a different yaw position. However, in the absence of power to the motor, the gears hold the rotor in a fixed yaw position. This approach involves the use of multiple parts which leads to multiple points of potential failure or mechanical wear. A further approach to yaw control features a freely rotating wind turbine where the yaw position of the rotor is controlled by the position of a vane. However, the yaw position of such wind turbines will depend entirely on the direction of the wind, and cannot be otherwise controlled or selectively adjusted.

A further problem with the above approaches to yaw control is that when no power is supplied to a wind turbine's control systems or mechanisms (e.g. when the wind turbine has shut down), wind may still blow against the blades of the wind turbine. This tends to drive the blades to rotate and/or realign the yaw position of the blades in a direction facing the incident wind. The worm gear approach, as well as the spring applied brake approach, will hold the yaw position of the rotor in the absence of power and thus, will not maintain a favorable orientation with the incident wind. Such rotors will experience greater mechanical stress as the control structures of wind turbine will be configured to resist such rotation or adjustment in the absence of power which may increase the maintenance problems and requirements of the wind turbine.

Another method of power regulation involves using a variable speed generator which is controlled to produce a constant torque value when the wind turbine operates in above rated power wind speed. In conjunction with constant torque control of the generator, the rotor speed is continuously monitored and compared with a target speed value (i.e. rotor speed corresponding to rated power). The control computer then derives a pitch position or pitch rate command based on the magnitude of difference between the actual rotor speed and the target rotor speed. Again, the pitch position or pitch rate command issued to the blade pitch actuators is the same for all blades, commonly referred to as a collective pitch command.

Some wind turbines have a hinge feature at the base end of each blade (referred to as a ‘flapping hinge’), and a rotor comprised of two or more such hinged blades can be referred to as a flapping hinge rotor. During rotation, such blades may be adjustable between different incline positions (e.g. relative to the rotational axis) with minimal resistance, and are biased towards an outward configuration (i.e. away from the axis of rotation) by centrifugal forces resulting from the rotation of the rotor. However, variations in wind speed can present problems for the rotor. A reduction in wind speed reduces the rotational speed of the rotor. Structural damage may result if there is insufficient centrifugal force to bias the blades in the outward configuration (e.g. the blades may collapse together). An increased wind speed increases the rotational speed of the rotor, but this can place additional stress on (and potentially damage) the internal control or support structures of the turbine.

In the case of a downwind flapping hinge rotor (i.e. a flapping hinge rotor which is placed downwind of the support tower), the aerodynamic loads acting on the blades during shut down tend to deflect the blades toward the tower. In particular, when the blades of a flapping hinge rotor are pitched to produce negative lift (e.g. to slow down the rotor), excessive negative lift can be produced which may cause a part of the blade to strike the tower supporting the rotor. This tendency is normally accommodated by increasing the bending stiffness of the blades to minimize interference between the blades and the tower. However, to increase bending stiffness, the blade design must as a consequence either (I) use more materials, (ii) be of larger sectional dimensions, or (iii) employ more expensive materials, all of which increase the cost of the blade.

However, the above solutions to pitch and yaw control are not suitable for flapping hinge rotors. When a flapping hinge rotor employs a collective pitch command for above rated power regulation, there will be occasions where the aerodynamic loading on one blade is substantially different from the aerodynamic loading on the other blade or other blades. The combined aerodynamic loading on all of the blades may sum to a value which does not cause a significant power or rotor speed excursion and thereby does not induce any changes to the collective pitch command from the control computer. However, the one blade may experience a substantially different aerodynamic loading and respond with a flap angle excursion. Sometimes the flap angle excursion can be severe enough to exceed normal operating bounds and induce potentially damaging structural loads (e.g. causing the blade to strike the tower).

Another problem related to the employment of flapping hinge rotors is that when the blades of the rotor are pitched to produce negative lift (to slow down the rotor), excessive negative lift can be produced which may cause a part of the blade to strike the tower supporting the rotor.

As such, there is an unmet need for a blade control system for a wind turbine which is especially well adapted to address one or more of the above issues or deficiencies or to at least provide a useful alternative to any existing solutions for wind turbines.

### SUMMARY OF THE INVENTION

The representative embodiments and modes of operation of the components and system described herein provide a plurality of blade control and positioning functions which may be employed individually, or in a combined fashion, and thereby provide a means of overcoming the various noted shortcomings of the prior art in blade control systems. In this manner, the device and method herein provided an improved system for blade control for such wind turbines while concurrently reducing the risk of a blade of a flapping hinge rotor from striking the tower whilst minimizing the need (and costs) for substantial additions of blade stiffness.

In one mode of blade control herein described and disclosed, the representative embodiments may include a rotor azimuth sensor. The rotor azimuth sensor can, in its most simple form, be a two position switch such as a non-contact proximity sensor. Each proximity sensor is used to register the critical zone in the rotation azimuth of each blade when there is a danger of interfering with the tower. For example, a different proximity sensor may be associated with each blade and each proximity sensor is used to register the critical zone in the rotational azimuth of its associated blade. Alternatively, the rotor azimuth sensor can employ multiple detection devices for each blade and thereby provide additional information to the control system. When a blade is within the critical azimuth zone, the flap angle target for that particular blade is adjusted to a larger value. As a consequence of the increased flap angle target, the bending loads on the blade are substantially diminished and the blade is no longer deflected toward the tower. Once the blade has past the critical azimuth zone, its flap angle target is returned to the normal value for shut-down. This technique can be applied individually to all blades.

According to this mode of the present invention, there is provided one manner of a control system for a wind turbine having a plurality of blades arranged for rotation about an axis, said blades being adjustable between different incline positions relative to said axis, said control system including:

one or more position sensors for detecting the presence of any said blade at one or

more different blade positions about said axis;

a flap controller for generating flap control data for adjusting an incline position of each detected said blade independently of each other; and

a blade pitch controller for detecting an incline position for each detected said blade, and selectively adjusting a pitch position of each detected said blade based on the flap control data and detected incline position for each detected said blade.

Employing this mode of the disclosed system, the present invention also provides a wind turbine including a system as described above.

Additionally, the present invention also provides a control method for a wind turbine having a plurality of blades arranged for rotation about an axis, said blades being adjustable between different incline positions relative to said axis, employing the steps of:

detecting the presence of any said blade at one or more different blade positions about said axis;

generating flap control data for adjusting an incline position of each detected said blade independently of each other;

detecting an incline position for each detected said blade; and selectively adjusting a pitch position of each detected said blade based on the flap control data and detected incline position for each detected said blade.

In the pitch control component of the disclosed system and method herein, the representative components described herein provide a means to mitigate or attenuate aerodynamic loading induced flap angle excursions by adding a flap position signal for each blade, to the input data to a control computer input. In this segment of the system herein, a control computer continuously monitors the flap angle signals from each blade. In the event of a blade experiencing a significantly differing aerodynamic load condition and consequent flap excursion, this will be immediately recognized by the control computer. The control computer software can be coded to respond to either a flap position excursion or a flap rate excursion or combinations of both. In the presence of a flap excursion, the control computer will adjust the pitch position or pitch rate command to the individual blade undergoing the excursion. The affect of the pitch adjustment will be to alter the aerodynamic loading acting on the blade and thereby attenuate or mitigate the flap excursion and avoid potentially damaging structural loads.

Employing this pitch control system there is provided a control system for a wind turbine having a plurality of blades arranged for rotation about an axis, the blades being adjustable between different incline positions relative to the axis, the control system including:

a speed sensor for detecting a rotational speed of said blades;

a flap controller for generating, based on the rotational speed, flap control data for adjusting the incline positions of one or more of said blades; and

a blade pitch controller for detecting the incline positions for one or more of said blades, and independently adjusting a pitch position of one or more of said blades based on the flap control data and the detected incline positions of the blades.

This component of the entire system herein described and disclosed additionally provides a wind turbine design which includes the pitch control system as described above.

Still further, this component of the disclosed invention also provides a blade pitch control method for a wind turbine having a plurality of blades arranged for rotation about an axis, said blades being adjustable between different incline positions relative to the axis, which employs the steps of:

detecting a rotational speed of said blades;

generating, based on the rotational speed, flap control data for adjusting the incline positions of one or more of said blades;

detecting the incline positions for one or more of the blades; and

flap control data and the detected incline positions of the blades.

Also provided as noted above is a yaw control component of the system and method herein disclosed. The representative yaw control described herein can be used with any wind turbine, including wind turbines with a flapping hinge rotor (i.e. a rotor having two or more blades where each blade is coupled to the rotor via a hinge feature at the base end of each blade).

According to this segment of the disclosed invention, there is provided a yaw control system for a wind turbine having a rotor with a plurality of blades arranged for rotation about a rotational axis, the yaw control system including a drive component which:

i) inhibits rotational resistance of said rotor to permit movement of said rotor between different yaw positions relative to a vertical axis of said turbine;

ii) is controllable for selectively moving said rotor from a first yaw position to a second yaw position; and

iii) is controllable for releasably engaging said rotor to resist further rotation of said rotor from a predetermined yaw position.

Still further, as with the other components of the system enabling the methods herein, this yaw control system also provides a wind turbine including a system as described above.

The foregoing has outlined rather broadly the more pertinent and important features of the device and method herein for blade control on a wind turbine in order that the detailed description of the invention that follows may be better understood so that the present contribution to the art may be more fully appreciated. Additional features of the invention will be described hereinafter which form the subject of the claims of the invention. It should be appreciated by those skilled in the art that the conception and the disclosed specific embodiment may be readily utilized as a basis for modifying or designing other modular systems for blade control which may be employed on a wind turbine. It should also be realized by those skilled in the art that such equivalent constructions and methods do not depart from the spirit and scope of the invention as set forth in the appended claims.

In this respect, before explaining at least one embodiment of the invention in detail, it is to be understood that the invention is not limited in its application to the details of construction and to the arrangement of the components and steps in the methods set forth in the following description or illustrated in the drawings. The invention herein is capable of other embodiments and of being practiced and carried out in various ways and the individual component portions thereof may be employed singularly or in concert. Also, it is to be understood that the phraseology and terminology employed herein are for the purpose of description and should not be regarded as limiting.

### THE OBJECTS OF THE INVENTION

It is therefore an object of the present invention to provide a control system for blades on a wind turbine which features individual components of the system which may be employed singularly or in combinations.

It is another object of this invention to provide such a control system which may be employed with a flapping hinged rotor to reduce the risk of a blade striking the support tower.

It is a further object of this invention, to provide such a modular control system which also minimizes costs and maintenance.

The foregoing has outlined some of the more pertinent objects of the invention. These objects should be construed to be merely illustrative of some of the more prominent features and applications of the intended blade control invention. Many other beneficial results can be attained by applying the disclosed method and control device in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

Representative embodiments of the present invention are herein described, by way of example only, with reference to the accompanying drawings, wherein:

FIG. 1 is a rear view of a wind turbine;

FIG. 2 is a side view of the wind turbine shown in FIG. 1;

FIG. 3 is a detailed side view of the structures between the blades and the hub;

FIG. 4 is a diagram of the components in a hydraulic pitch actuator; and

FIG. 5 is a block diagram of a pitch control system;

FIG. 6 is a flow diagram of a pitch control process;

FIG. 6A is a flow diagram of a modified pitch control process; and

FIGS. 7, 8, 9 and 10 are block diagrams showing the components in a hydraulic flap actuator configured in a parked state, start-up state, power-production state, and shutdown state respectively.

FIG. 11 is a block diagram of a yaw drive system setup in a de-energized state;

FIGS. 12 and 13are block diagrams of a drive system setup for changing a yaw position of the rotor in one direction and in an opposite direction respectively;

FIG. 14 is a block diagram of a drive system setup for resisting yaw rotation;

FIG. 15 is a block diagram of a drive system setup for enabling free yaw rotation;

### DETAILED DESCRIPTION OF THE PREFERRED EMBODIMENTS

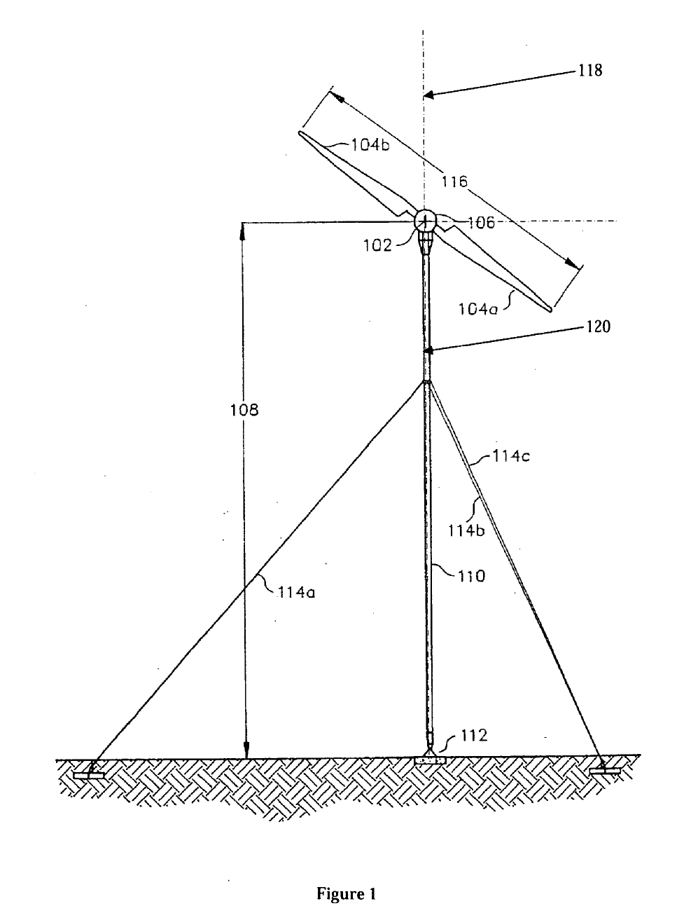

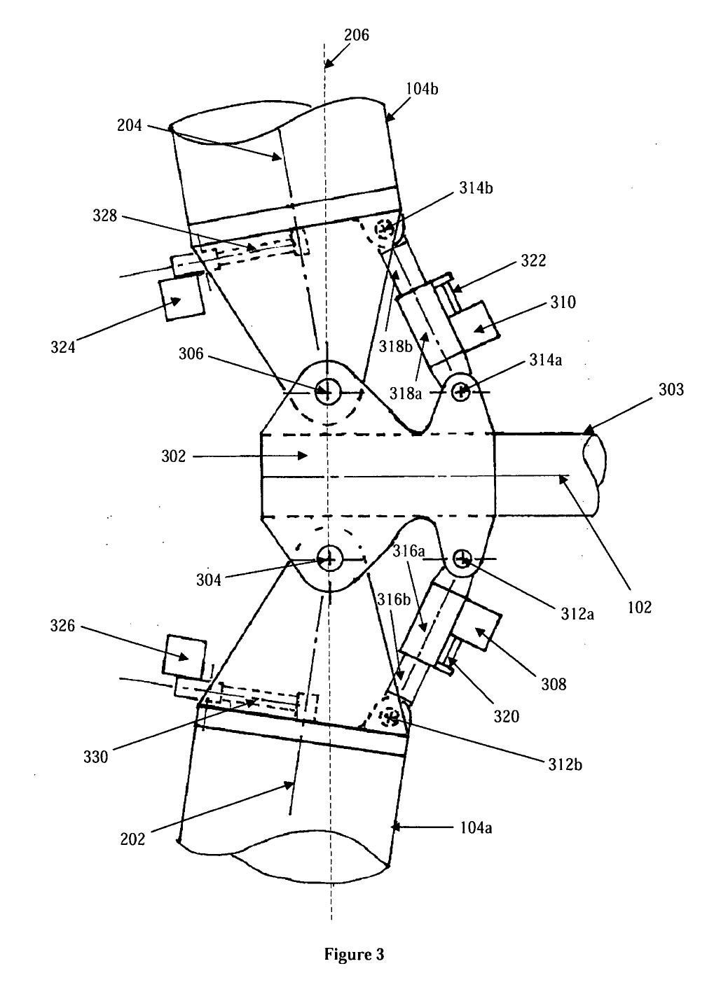

Referring now to the drawings 1-15, wherein similar parts of the invention are identified by like reference numerals, there is shown in FIG. 1, a wind turbine 100, which includes a plurality of blades 104a and 104b coupled to a hub 302 (see FIG. 3) located within a housing 106. The blades 104a and 104b are rotatable (e.g. together with the hub 302) about a rotational axis 102. A tower 110 supports the housing 106 at a height 108 about the ground. The height 108 should be greater than half the span length 116 of the blades 104a and 104b to avoid the blades from hitting the ground. The tower 110 has a base portion 112 that is connected to the ground. The tower 110 may have one or more guy wires 114a, 114b and 114c connecting the tower 110 to anchors on the ground to help secure and stabilize the tower 110 (e.g. when the wind turbine 100 is operating in high wind conditions).

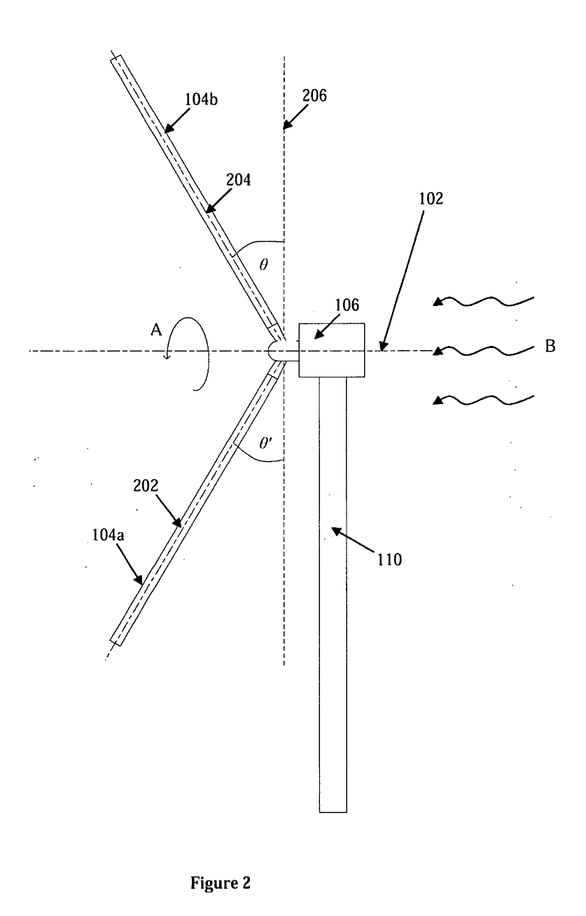

FIG. 2 is a side view of the wind turbine 100 shown in FIG. 1. The blades 104a and 104b of the wind turbine 100 rotate about a rotational axis 102 (in a direction indicated by arrow A) in reaction to the force exerted onto the blades 104a and 104b by wind flowing in a direction indicated by the arrows B. Each of the blades 104a and 104b has a longitudinal axis 202 and 204 that runs along the length of each blade. Each blade 104a and 104b has an end portion that is pivotally coupled to a hub 302 (as shown in FIG. 3).

Each of the blades 104a and 104b can be moved or adjusted to an incline position relative to the rotational axis 102. For example, each blade 104a and 104b may be inclined to a position forming a flap angle (represented by θ and θ′ in FIG. 2) relative to the rotational axis 102, or alternatively, a rotational plane 206 that is substantially normal to the rotational axis 102. The blades 104a and 104b may be initially configured to a first incline position (e.g. with a minimal flap angle) so that the blades 104a and 104b can rotate substantially in parallel with the rotational plane 206. However, during rotation, the blades 104a and 104b may be moveable to a different incline position (e.g. to a greater flap angle up to a predetermined maximum flap angle). During rotation, the flap angle of each blade 104a and 104b may vary due to a combination of centrifugal forces and aerodynamic forces exerted onto each respective blade 104a and 104b by the wind.

In the representative embodiment shown in FIGS. 1 and 2, the blades 104a and 104b of the wind turbine 100 rotate in a clockwise direction about the rotational axis 102. The blades 104a and 104b therefore have a rotational path that circles around the rotational axis 102. The rotational path can be divided into an approach region and a trail region. The approach region refers to a part of the rotor's rotational path where the tip of the blades 104a and 104b being to approach (or move towards) the tower 110. The approach region may be defined as any portion of the rotational path of the blades 104a and 104b between a starting point 118 located directly above the rotational axis 102 and an ending point 120 located directly below the rotational axis 102.

The trail region refers to a part of the rotor's rotational path where the tips of the blades 104a and 104b move away from the tower 110. The trail region may be defined as any portion of the rotational path of the blades 104a and 104b between a starting point 120 located directly below the rotational axis 102 and an ending point 118 located directly above the rotational axis 102.

When the blades 104a and 104b of the rotor (as shown in FIGS. 1 and 2) are placed at a pitch position that generates negative aerodynamic lift (e.g. for reducing the rotational speed of the rotor), the blades 104a and 104b tend to move in an upwind direction towards the tower 110. The internal control and support structures for each blade 104a and 104b allow the blades 104a and 104b to move in an upwind direction up to a certain point (e.g. to a maximum incline position with the smallest flap angle). But if the blades 104a and 104b generate excessive negative aerodynamic lift, the aerodynamic forces acting on the blades may cause the blades 104a and 104b to bend along its length, which may result in a tip of a blade 104a and 104b striking the tower 110. In particular, when the blades 104a and 104b rotate, any blade 104a and 104b in the approach region of the rotor has a higher risk of striking the tower 110.

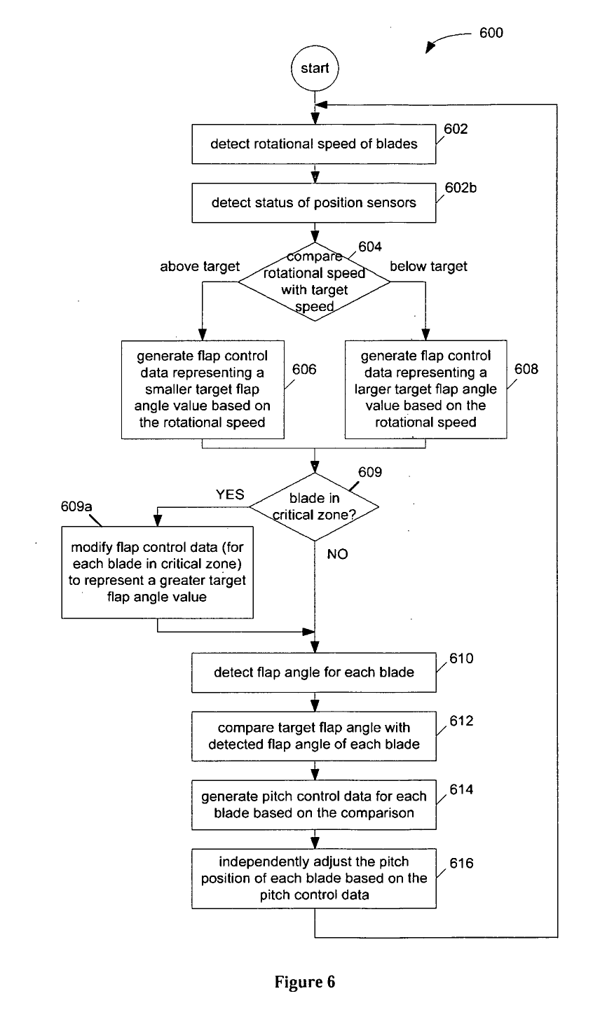

To help minimize the risk of such structural damage, the control system 500 (shown in FIG. 5) detects whether any particular blade 104a and 104b has rotated to a blade position about the rotational axis 102 which places that blade 104a and 104b at risk of striking the tower 110. The control system 500 adjusts at least the incline position of that blade 104a and 104b to a smaller incline position (i.e. a position with a greater flap angle to move the blade further away from the tower 110). The control system 500 adjusts the incline position of the relevant blade 104a and 104b by selectively adjusting the pitch position of that blade 104a and 104b.

For example, a blade 104a and 104b may be determined as being at risk of striking the tower if the blade 104a and 104b has rotated to a blade position within a critical zone of the rotor. The critical zone may be defined as the region along the rotor's rotational path between a start blade position (e.g. located within the approach region of the rotor) and an end blade position (e.g. located within the trail region of the rotor). The control system 500 may include one or more position sensors for detecting the presence of a blade 104a and 104b at one or more different blade positions about the rotational axis 102. The position sensors 507 may be placed at different locations (e.g. on the nacelle) so that each position sensor 507 for detecting different blade positions of the blades 104a and 104b about the rotational axis 102. For example, different position sensors may be used for detecting the presence of a blade 104a and 104b at the start and end blade positions of the critical zone respectively.

When the control system 500 detects a blade 104a and 104b is at the starting blade position of the critical zone, the control system 500 generates flap control data for reducing the incline position (or increasing the flap angle) of that particular blade 104a and 104b. This attempts to position the blade 104a and 104b further away form the tower. When the control system 500 detects that particular blade 104a and 104b has rotated to the ending blade position of the critical zone, the control system 500 generates flap control data for increasing the incline position (or decreasing the flap angle) of that particular blade 104a and 104b (e.g. to allow that blade 104a and 104b to move towards an original incline position (or flap angle) prior to making the adjustments made by reason of the blade 104a and 104b entering the critical zone). The manner in which the control system 500 controls the blades 104a and 104b of the wind turbine 100 are explained in greater detail below.

FIG. 3 is diagram showing an example of the connecting structures between the blades 104a and 104b and the hub 302. The hub 302 is the structure that couples the blades 104a and 104b to a drive shaft 303. The rotation of the blades 104a and 104b causes the hub 302 and the drive shaft 303 to rotate. One end of the drive shaft 303 may be coupled to an electric generator (not shown in FIG. 3). The generator produces electricity when the drive shaft 303 is rotated by the blades 104a and 104b.

Each blade 104a and 104b has an end portion that is pivotally coupled to the hub 302, so that each blade 104a and 104b can pivot about a respective pivot axis 304 and 306. The incline position of each blade 104a and 104b (relative to the plane of rotation 206) is controlled by one or more flap actuators 308 and 310, which controls (and allows adjustments of) the relative distance between a pivot point 312b and 314b of a blade 104a and 104b and a pivot point 312a and 314a of the hub 302.

In one representative embodiment, each blade 104a and 104b is adjustable to different pitch positions by rotating about its respective longitudinal axis 202 and 204. Each blade 104a and 104b has a different pitch actuator 324 and 326 for independently adjusting the pitch position of each blade 104a and 104b. Each of the pitch actuators 324 and 326 may be a hydraulic actuator, which moves a driving arm 328 and 330 towards or away from the respective pitch actuator 324 and 326 by controlling the application of hydraulic pressure.

The incline position of all blades 104a and 104b of the wind turbine 100 may be controlled by a single flap actuator 308 or 310. In another representative embodiment, shown in FIG. 3, the incline position of each blade 104a and 104b may be respectively controlled by a different flap actuator 308 and 310. Each of the flap actuators 308 and 310 may be hydraulic actuator, which moves a driving arm 320 and 322 towards or away from the respective flap actuator 308 and 310 by controlling the application of hydraulic pressure.

In the representative embodiment shown in FIG. 3, each flap actuator 308 and 310 controls the extension or retraction of an arm assembly, which moves the incline position of the blades 104a and 104b to a greater or lesser flap angle respectively. Each arm assembly includes a first arm portion 316a and 318a having a bore formed therein for receiving a smaller second arm portion 316b and 318b. The first and second arm portions 316a, 316b, 318a and 318b can move towards or away from each other (e.g. under the control of a flap actuator 308 and 310) in order to retract or extend the overall length of the arm assembly. For example, the flap actuator 308 and 310 may be securely coupled to the first arm portions 316a and 318a, and the end of the arms 320 and 322 may be securely coupled to the second arm portions 316b and 318b (or vice versa). In this configuration, extension or retraction of each actuator's arm 320 and 322 causes the arm assembly to extend or retract accordingly.

An end portion of each first arm portion 316a and 318a is pivotally coupled to the hub 302, so that each first arm portion 316a and 318a can pivot about a respective pivot point 312a and 314a on the hub 302. Similarly, an end portion of each second arm portion 316b and 318b is pivotally coupled to a blade 104a and 104b, so that each second arm portion 316b and 318b can pivot about another pivot point 312b and 314b on the blade 104a and 104b.

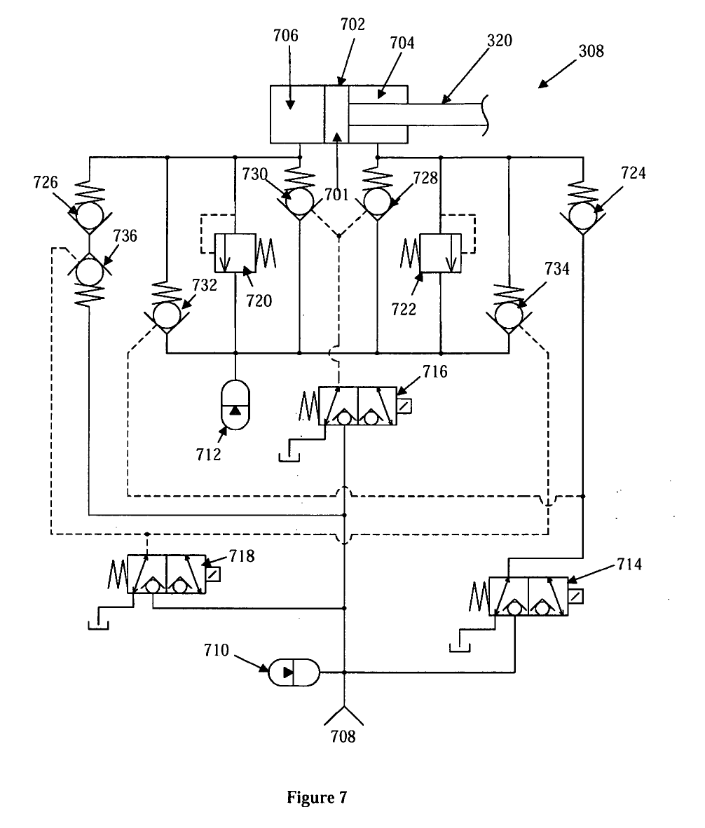

FIG. 7 is a block diagram showing the hydraulic components in a representative embodiment of an actuator 308 (when configured in a parked state). Each actuator 308 and 310 has the same components, and operate in the same way. The parked state represents the configuration where all valves of the actuator 308 and 310 are in the de-energized state. The actuator 308 has a cylinder 702, which houses a piston 701 formed at one end of the arm 320. The cylinder 702 has a front end with an opening through which the arm 320 extends. The piston 701 divides the cylinder 702 into a front chamber 704 and a rear chamber 706. When hydraulic fluid is fed into the front chamber 704, the piston 701 is pushed away from the front end, which retracts the arm 320 into the cylinder 702. This causes the arm assembly to retract and position the blade 104a to an incline position with a smaller flap angle. When hydraulic fluid is fed into the rear chamber 706, the piston 701 is pushed towards the front end, which extends the arm 320 from the cylinder 702. This causes the arm assembly to extend and position the blade 104a to an incline position with a greater flap angle.

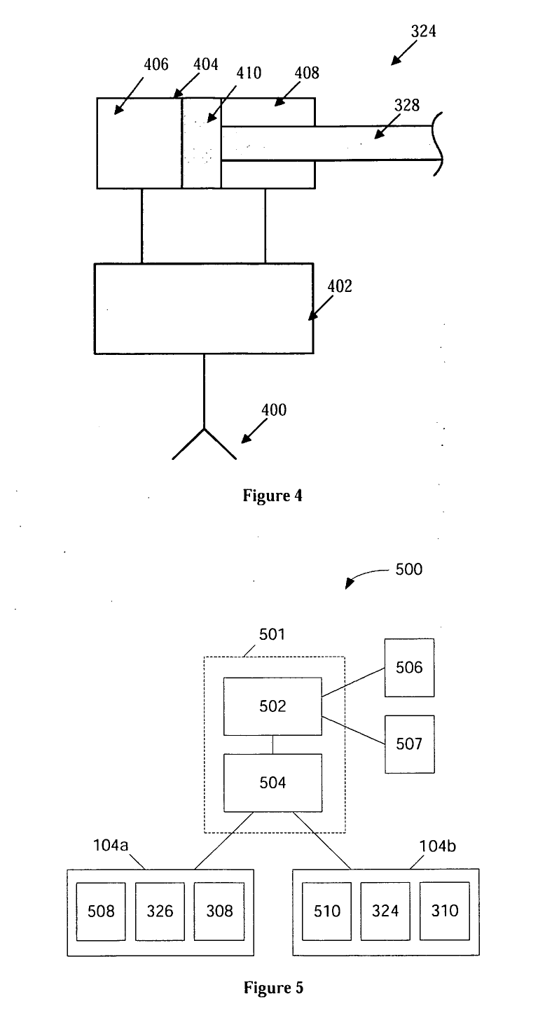

FIG. 4 is a diagram of the components inside a pitch actuator 324 for a representative embodiment of the invention. The components for other pitch actuators 326 for the wind turbine 100 can be the same. The pitch actuator 324 has a high pressure source 400 that is connected to one or more spool-type hydraulic servo valves 402. For simplicity, only one hydraulic servo valve 402 is shown in FIG. 4. The position of a spool within the servo valve 402 may be controlled by a command signal. For example, the spool may move in either a positive or negative direction in direct proportion to the direction and magnitude of the command signal (e.g. an electric current).

The position of the spool determines the direction and rate of flow of hydraulic fluid in either the front chamber 408 or rear chamber 406 of the hydraulic cylinder 404. For example, when hydraulic fluid flows into the rear chamber 406, the hydraulic pressure drives the piston 410 towards the open end of the cylinder 404 to extend the driving arm 328. When hydraulic fluid flows into the front chamber 408, the hydraulic pressure drives the piston 410 away from the open end of the cylinder 404 to retract the driving arm 328. Extending the driving arm 328 may cause the blade 104b to rotate about axis 204 and result in a decrease in the pitch position. Similarly, retracting the driving arm 328 may cause the blade 104b to rotate and result in an increase in the pitch position.

The ability for the blades 104a and 104b to move to a different incline position (or “flap”) is particularly advantageous for power production. For example, if the wind turbine 100 receives a sudden gust of strong wind, the blades 104a and 104b can deflect to a different incline position to absorb at least some of the force of the wind, thus reducing the amount of force (and potentially damage) placed on the blade coupling mechanism that connects each blade 104a and 104b to the hub 302.

FIG. 5 is a block diagram showing the components of a pitch control system 500 for controlling the pitch position of the blades 104a and 104b (e.g. during power production). The pitch control system 500 includes a control unit 501 having a flap controller 502 and a blade pitch controller 504. The control unit 501 communicates with a speed sensor 506. The control unit 501 also communicates with the respective flap angle sensors 508 and 510, pitch actuators 324 and 326, and flap actuators 308 and 310 for each of the blades 104a and 104b.

The control unit 501 includes a processor, and for example, the control unit 501 may be a standard industrial duty computer running a real-time operating system. The processes performed by the flap controller 502 and blade pitch controller 504 may be provided by way of computer program code (e.g. in languages such as C++ or Ada). However, those skilled in the art will also appreciate that the processes performed by the flap controller 502 and blade pitch controller 504 can also be executed at least in part by dedicated hardware circuits, e.g. Application Specific Integrated Circuits (ASICs) or Field-Programmable Gate Arrays (FPGAs).

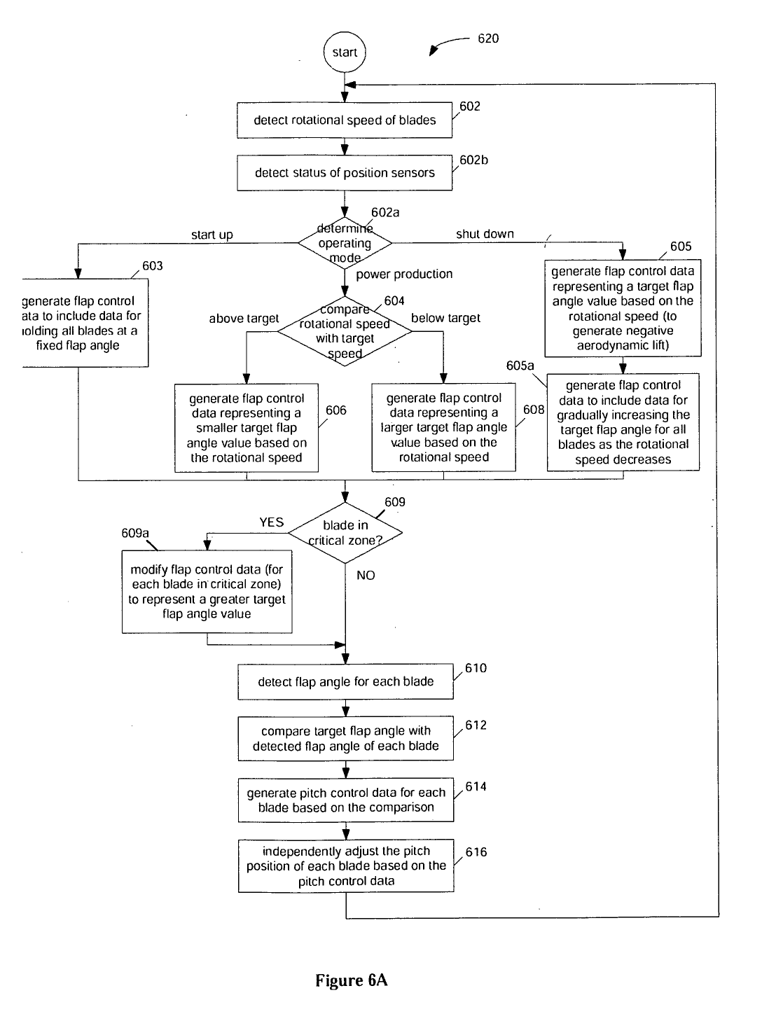

FIG. 6 is a flow diagram of a pitch control process 600 that is performed under the control of the pitch control system 500, or more specifically, the control unit 501. Process 600 is for use when the wind turbine is producing power. Process 600 begins at step 602 where the speed sensor 506 detects the rotational speed of the blades 104a and 104b rotating about axis 102 (i.e. the rotor speed). The speed sensor 506 generates (e.g. in real time) speed data representing the detected rotational speed. The speed data is provided to the flap controller 502.

At step 604, the flap controller 502 compares the rotational speed represented by the speed data with a predetermined target speed. In a representative embodiment, the target speed represents a predetermined rotational speed of the blades during power production (e.g. a rotational speed of the blades producing a maximum rated power output). If step 604 determines that the rotational speed is less than the target speed, this indicates that the blades 104a and 104b are not rotating sufficiently quickly to produce a maximum rated power output, and control passes to step 608 to increase a target flap angle value for increasing the rotational speed of the blades 104a and 104b. However, if step 604 determines that the rotational speed is greater than the target speed, this indicates that the blades 104a and 104b are rotating too quickly, and control passes to step 606 to decrease a target flap angle value for decreasing the rotational speed of the blades 104a and 104b.

It should be noted that by increasing in the angle of attack of a blades 104a and 104b, the aerodynamic lift exerted by that blade 104a and 104b will also increase. This increases the torque produced by the rotor, and in turn, also increases the flap angle (i.e. decreases the incline position) for the blades 104a and 104b since the actual incline position of a blade 104a and 104b depends on the net effect of the aerodynamic lift (which, if increasing in value, tends to move the blades to a greater flap angle position or, if decreasing in value, tends to move the blades to a smaller flap angle position) and centrifugal forces (which tends to move the blades to a smaller (e.g. zero) flap angle position) acting on the blade 104a and 104b.

Accordingly, at step 606, the flap controller 502 responds to an over target rotor speed by attempting to decrease the rotor speed (or rotor torque) by generating flap control data for decreasing a target flap angle (i.e. to increase the incline position) of one or more of the blades 104a and 104b. To move the blades 104a and 104b to a smaller flap angle position (consistent with flap control data), the blades 104a and 104b are pitched to a position that generates less aerodynamic lift, so that the net effect of the forces acting on each of the blades 104a and 104b (e.g. when the centrifugal force acting on a blade is greater than the aerodynamic lift produced by that blade) tends to move each blade 104a and 104b towards a smaller flap angle position. As a result, the pitch control data generated at step 614 (based on the flap control data generated at step 606) controls the pitch actuators 324 and 326 to increase the pitch angle of one or more blades 104a and 104b.

The flap control data generated at step 606 represents one or more commands, instructions or parameters (generated based on the rotational speed of the blades 104a and 104b) for decreasing a target flap angle (i.e. increasing the incline position) of one or more blades 104a and 104b. In a representative embodiment, the flap control data may include data representing a specific target flap angle value which all of the blades 104a and 104b incline towards by making adjusts to their respective pitch position. For example, the target flap angle value may be one of several predefined flap angle values selected based on the rotational speed of the blades 104a and 104b.

In another representative embodiment, the target flap angle value is generated based on a change in the rotational speed of the blades 104a and 104b as detected by the speed sensor 406, which may involve one or more of the following calculations (e.g. using a proportional-integral-derivative (PID) controller):

i) generating a target flap angle value in proportion to an error value determine based on the difference between the detected rotational speed and the target speed;

ii) generating a target flap angle value based on an integral representing a sum of the error values (i.e. differences between the detected rotational speed and target speed) over a set period of time; and

iii) generating a target flap angle value based on a derivative representing a rate at which the error values (i.e. differences between the detected rotational speed and target speed) have changed over a set period of time.

The target flap angle value may also be generated based on any other correlation or relationship based on the rotational speed detected by the speed sensor 406, including linear, quadratic and Gaussian relationships (e.g. using a linear-quadratic-gaussian (LQG) controller).

For each of the above correlations or relationships, the relevant input values (e.g. the error values) used for generating a target flap angle value may be multiplied by a different multiplier value (K). By using different multiplier values for calculations of the target flap angle value based on different correlations or relationships, it is possible to adjust (or optimize) the value of the target flap angle value generated depending on various characteristics of a turbine rotor (e.g. its size, rotational speed, inertial properties and aerodynamic properties).

Similarly, at step 608, the flap controller 502 responds to a below target rotor speed by attempting to increase the rotor speed (or rotor torque) by generating flap control data (representing one or more commands, instructions or parameters) for increasing the target flap angles (e.g. to decrease the respective incline positions) of one or more of the blades 104a and 104b. To move the blades 104a and 104b to a greater flap angle position (consistent with flap control data), the blades 104a and 104b are pitched to a position that generates greater aerodynamic lift, so that the net effect of the forces acting on each of the blades 104a and 104b (e.g. when the centrifugal force acting on a blade is less than the aerodynamic lift produced by that blade) tends to move each blade 104a and 104b towards a greater flap angle position. As a result, the pitch control data generated at step 614 (based on the flap control data generated at step 608) controls the pitch actuators 324 and 326 to increase the pitch angle of one or more blades 104a and 104b.

Similar to step 606, the flap control data generated at step 608 represents one or more commands, instructions or parameters (generated based on the rotational speed of the blades 104a and 104b) for increasing a target flap angle (i.e. decreasing the incline position) of one or more of the blades 104a and 104b. The flap control data generated at step 608 (similar to that generated at step 606) may include data representing a specific target flap angle value which all of the blades 104a and 104b incline towards by making adjusts to their respective pitch position, or a target flap angle value generated based on a change in the rotational speed of the blades 104a and 104b.

Steps 606 and 608 both proceed to step 610. At step 610, the flap controller 502 sends the flap control data to the blade pitch controller 504. In a representative embodiment, the blade pitch controller 504 controls each of the flap angle sensors 508 and 510 to detect a current flap angle value for each of the blades. The flap angle sensors 508 and 510 then generate flap angle data representing the detected flap angle value for each of the blades 104a and 104b, and transmits the flap angle data to the blade pitch controller 504.

At step 612, the blade pitch controller 504 compares the target flap angle value (generated at either step 606 or 608) to the detected flap angle values for each blade 104a and 104b (as represented by the flap angle data).

At step 614, the blade pitch controller 504 generates (based on the comparison at step 612) pitch control data for independently adjusting the pitch of one or more of the blades 104a and 104b. For example, the pitch control data may include data representing one or more of the following:

i) a pitch angle; and

ii) a pitch angle and a period of time for carrying out the pitch adjustment (e.g. for determining the magnitude and rate of pitch angle adjustment over that period of time).

The pitch angle for a blade 104a and 104b may be a predefined fixed value (which allows incremental adjustments to the pitch position of the blades 104a and 104b over a set period of time). Alternatively, the pitch angle for a particular blade 104a and 104b may be generated based on a change in the flap angle value for that blade over time (for example where the flap angle value for a blade 104a and 104b may be generated based on a proportional, integral, derivative, linear, quadratic or Gaussian relationship or correlation with the change in the flap angle value for the blade over time, in a similar manner to the calculation of the target flap angle as described above).

At step 616, the blade pitch controller independently adjusts the pitch position of one or more of the blades 104a and 104b (or, in a representative embodiment, each of the blades) based on the pitch control data for the respective blades. Step 616 then proceeds to step 602, where process 600 repeats until the wind turbine is no longer in power production mode.

The pitch control process 600 may be performed several times per revolution of the blade 104a and 104b, which allows finer adjustments to be made to the pitch of the blades 104a and 104b. For example, in a representative embodiment, the pitch control process 600 is performed between 10 to 100 times per revolution.

1. Limits for target flap angle: Set-point limits for minimum and maximum values for the flap angle can be applied. For example, steps 606 and 608 may include a conditional check on each execution cycle to ensure that the set-point limits are not exceeded. The set-point limit for a maximum target flap angle may be set at 15 degrees. The set-point limit for a minimum target flap angle may be set at 1.5 degrees.
2. Limits for pitch position: A set point limit for minimum pitch position can be employed, the value of which will be approximately +1 degrees. For example, step 614 may include a conditional check on each code execution cycle to ensure that pitch commands are not less than this value.
3. Initial value for commanded flap angle: When the turbine transitions from startup to power production, the initial target flap angle value will be the maximum permitted by the set-point limit. If entry to power production occurs with wind speed is less than the rated power value, the target flap angle value will remain at this value since rotor speed will be less than the set-point target. If entry to power production occurs with wind speed in excess of rated power value, rotor speed will initially exceed (overshoot) the set-point target which will then trigger a downward adjustment in target flap angle value. The magnitude of the downward adjustment in the target flap angle value can be derived from the magnitude of the rotor speed deviation in excess of set-point, using a suitable control algorithm (e.g. based on a PID controller). With each subsequent code execution cycle the commanded flap angle value can be revised in accordance with the degree to which rotor speed deviates from set point. As operation continues, should the wind speed then diminish and thereby reduce rotor speed to a value less than set-point, the reverse action will take place, i.e., the target flap angle value will be increased. In effect, because the wind speed is constantly varying the rotor speed will always be either increasing or decreasing and the commanded flap angle value will always be either increasing or decreasing in an effort to moderate the rotor speed fluctuations. Pitch motion for each blade will, accordingly, be constantly acting to maintain blade flap position at the current target flap angle value.

Another representative embodiment of the invention relates to controlling the flap angle (or incline position) of each of the blades 104a and 104b during start up and shut down of the rotor by independently adjusting the pitch of one or more blades 104a and 104b of the rotor. During start up, the blades 104a and 104b are allowed to rotate from an initial (e.g. stationary) position and accelerate up to a predetermined rotational speed (i.e. the target rotational speed) for producing a maximum rated power output. During shut down, the blades 104a and 104b are configured to decelerate in rotational speed (e.g. until the blades are ultimately in a stationary position).

FIG. 6A is a flow diagram of a modified pitch control process 620 that is performed under the control of the pitch control system 500, or more specifically, the control unit 501. Process 620 performs all of the steps in the pitch control process 600, but further includes additional steps 602a, 603, 603a, 605 and 605a. Process 620 begins at step 602 where the speed sensor 506 detects the rotational speed of the blades 104a and 104b rotating about axis 102 (i.e. the rotor speed). The speed sensor 506 generates (e.g. in real time) speed data representing the detected rotational speed. The speed data is provided to the flap controller 502.

At step 602a the flap controller 502 determines whether the wind turbine 100 is configured to operate in a start up mode, shut down mode or power production mode. The determination at step 602a may be performed by reference to the configuration data stored in a configuration file or generated by a configuration system (which may be part of, or remote from, the wind turbine 100).

If step 602a determines that the wind turbine 100 is configured to operate in the power production mode, control passes to step 604 and process 620 operates in the same manner as process 600 (as described above).

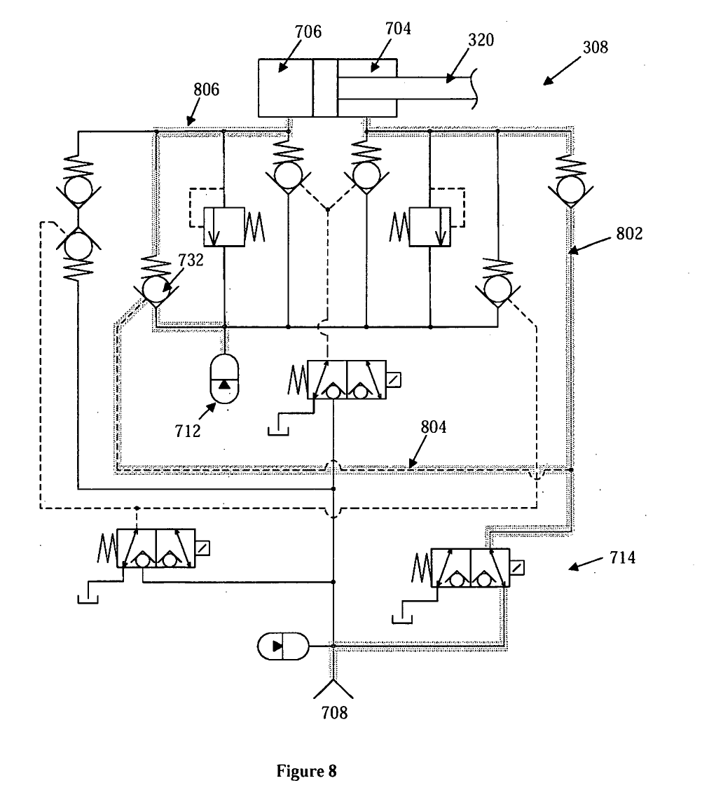

If step 602a determines that the wind turbine 100 is configured in the start up mode, control passes to step 603, where the flap controller 502 generates flap control data including data for controlling the flap actuators 308 and 310 to hold the blades 104a and 104b at a predetermined incline position. For example, this may involve adjusting the flap actuators 308 and 310 to the retracted position (as described with reference to FIG. 8 below) which moves the blades to a predetermined flap angle (e.g. between 2 to 4 degrees from the rotational plane 204). The flap control data generated at step 603 may further include commands, instructions or parameters for controlling step 614 to generate pitch control data representing a predetermined initial pitch value, so that the blades 104a and 104b are adjusted to an initial pitch position that encourages the rotor to build up rotational speed by harnessing the energy from the wind.

If step 602 determines that the wind turbine 100 is configured in the shut down mode, control passes to step 605. During shut down, the rotor may reduce its rotational speed by adjusting the pitch angle of most or all of the blades 104a and 104b to generate negative lift. When a blade 104a and 104b of a free flapping rotor is pitched to generated negative lift, the blade 104a and 104b will tend to move towards the upwind position. This is highly undesirable in the wind turbine configuration shown in FIG. 2, since a part of a blade 104a and 104b that produces excessive negative lift may flex past the rotational plane 204 and strike the tower 110.

To compensate for a blade 104a and 104b generating too much negative lift, at step 605, the flap controller 502 generates flap control data including data representing a progressively larger target flap angle value based on the rotor speed detected at step 602. Generally, step 605 generates a progressively larger target flap angle value as the rotational speed of the blades 104a and 104b progressively decreases.

An example of this relationship is described in Table 1 below:

| Rotational speed (as a | |
|---|---|
| percentage of the target | |
| speed) | Target flap angle value |
| 130% | −1° |
| 120% | 0° |
| 100% | +2° |
| 60% | +10° |

In a representative embodiment, the flap controller 502 (at step 605) uses the current rotational speed of the rotor (detected at step 602) for searching a lookup table (or hash) to retrieve a corresponding target flap angle value.

Preferably, the relationship between the rotational speed and the target flap angle value is such that, for any given rotational speed, the target flap angle value allows step 614 to configure the relevant blade 104a and 104b to generate sufficient negative lift but avoiding stalling of the blades. For example, the relationship between the rotational speed and the target flap angle may be an exponential relationship where at reduced rotational speeds, a greater compensatory adjustment is made to the target flap angle value of the blades 104a and 104b.

Step 605 then passes control to step 605a, where the flap controller 502 generates flap control data including data for controlling one or more flap actuators 308 and 310 to be progressively configured (over time) to a greater extended position (as described with reference to FIG. 8 below). The gradual extension of the flap actuators 308 and 310 can:
i) provide support for the blades 104a and 104b, which may tend to flap towards the rotational axis 102 as the decreasing centrifugal force acting on the blades (resulting from the reduced rotational speed of the rotor) becomes insufficient for keeping the blades 104a and 104b apart from each other; and
ii) provide resistance for part of the blades 104a and 104b from flexing past the rotational plane 206 to reduce the risk of the blade 104a and 104b striking the tower.

As shown in FIG. 7, the actuator 308 includes a high pressure source 708, low pressure sources 710 and 712, a blade retract valve 714, a blade restraint valve 716, a blade extend valve 718, pressure releasing valves 720 and 722, one-way valves 724 and 726 and pilot valves 728, 730, 732, 734 and 736. The blade retract valve 714, blade restraint valve 716, and blade extend valve 718 each may be a solenoid controlled valve having 2 positions, one position corresponding to a de-energized solenoid (corresponding to an off state which resists high pressure fluid from flowing through the valve and allows low pressure fluid to flow through the valve) and a second position corresponding to an energized solenoid (corresponding to an on state which allows high pressure fluid to flow through the valve and resists low pressure fluid from flowing through the valve), and 3 fluid connection ports.

In the configuration shown in FIG. 7, the blade retract valve 714, blade restraint valve 716, and blade extend valve 718 are all in the de-energized state (or off state). This prevents hydraulic fluid from the high pressure source 708 from adjusting the position of the arm 320. The arm 320 is therefore securely held in its current position (relative to the cylinder), which resists movement of the corresponding blade 104a to a different incline position.

FIG. 8 is a block diagram showing the hydraulic components in a representative embodiment of an actuator 308 (when configured in a start-up state). In this state, the blade retract valve 714 is energized (under the control of the flap control data from the flap controller 502). Hydraulic fluid from the high pressure source 708 flows via path 802 into the front chamber 704. At the same time, hydraulic fluid travels via path 804 to open the pilot valve 732, which allows any hydraulic fluid in the rear chamber 706 to flow (via path 806) into the low pressure source 712. In this configuration, the arm 320 (and arm assembly 316a and 316b) retracts and moves the blade 104a to an incline position with a minimal flap angle. Note that during start-up, once the blades have been positioned to the desired flap angle, the valve 714 is de-energized. Then the parking brake is released and the rotor begins accelerating in response to a progressive pitching of the blades in the direction of decreasing value. On reaching target rotor speed, transition to power production occurs. During the rotor acceleration phase of start-up, prior to reaching target rotor speed, the flap actuators assume the de-energized condition as depicted in FIG. 7.

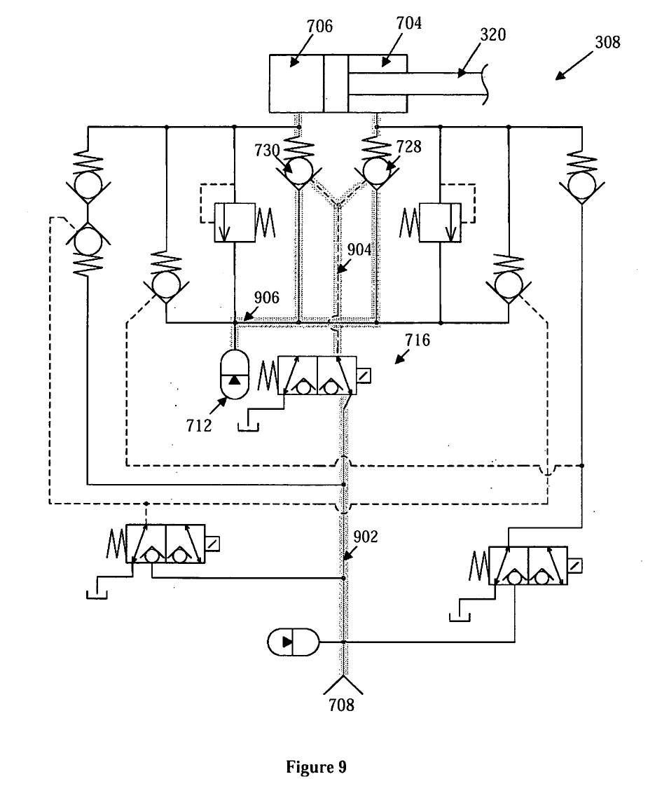

FIG. 9 is a block diagram showing the hydraulic components in a representative embodiment of an actuator 308 (when configured in a power-production state). In this state, the blade restraint valve 716 is energized (under the control of the flap control data from the flap controller 502). Hydraulic fluid from the high pressure source 708 flows via paths 902 and 904 to open the pilot valves 728 and 730. This establishes a path 906 that allows the hydraulic fluid in the front chamber 704 to flow into the rear chamber 706 (and vice versa) with minimal resistance. Such flow is also assisted by hydraulic pressure provided by the low pressure source 712. In this configuration, the arm 320 (and arm assembly 316a and 316b) can extend or retract with minimal resistance. This allows the blade 104a to move to any incline position depending on the centrifugal and aerodynamic forces exerted on the blade 104a.

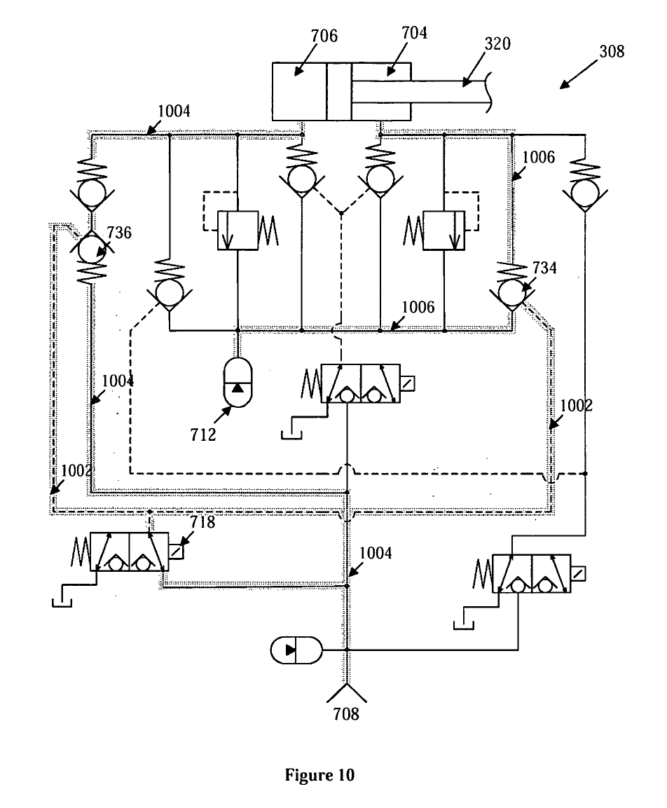

FIG. 10 is a block diagram showing the hydraulic components in a representative embodiment of an actuator 308 (when configured in a shut-down state). In this state, the blade extend valve 718 is energized (under the control of the flap control data from the flap controller 502). Hydraulic pressure from the high pressure source 708 flows via path 1002 to open the pilot valves 734 and 736. When the pilot valve 736 opens, hydraulic fluid from the high pressure source 708 flows (via path 1004) into the rear chamber 706 of the cylinder 702. When the pilot valve 734 opens, hydraulic fluid in the front chamber 704 flows (via path 1006) into the low pressure source 712. In this configuration, the arm 320 (and arm assembly 316a and 316b) extends and moves the blade 104a to an incline position with a greater flap angle.

The ability for the blades 104a and 104b to move to a different incline position (or “flap”) is particularly advantageous for power production. For example, if the wind turbine 100 receives a sudden gust of strong wind, the blades 104a and 104b can deflect to a different incline position to absorb at least some of the force of the wind, thus reducing the amount of force (and potentially damage) placed on the blade coupling mechanism that connects each blade 104a and 104b to the hub 302.

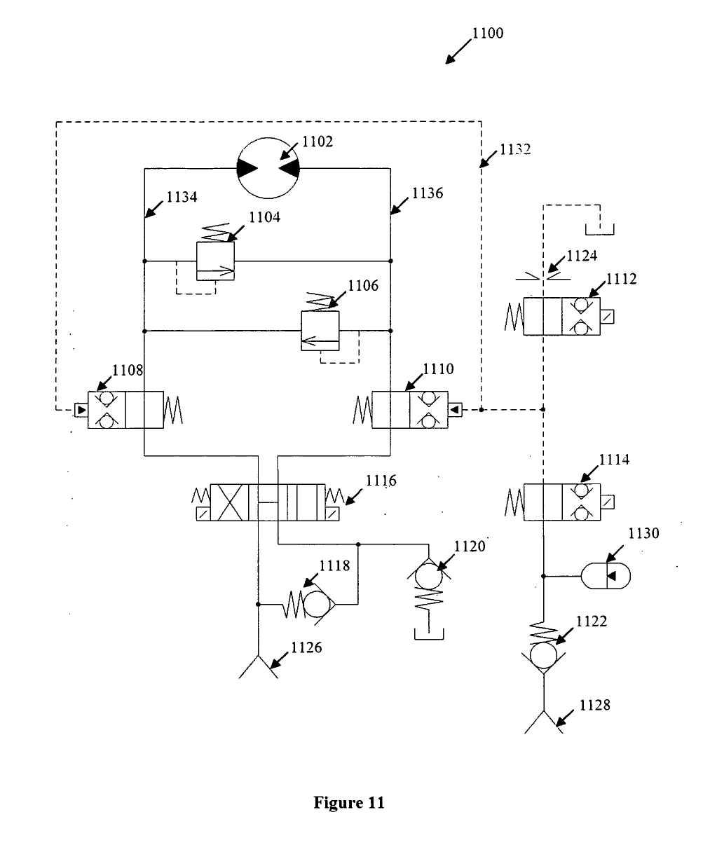

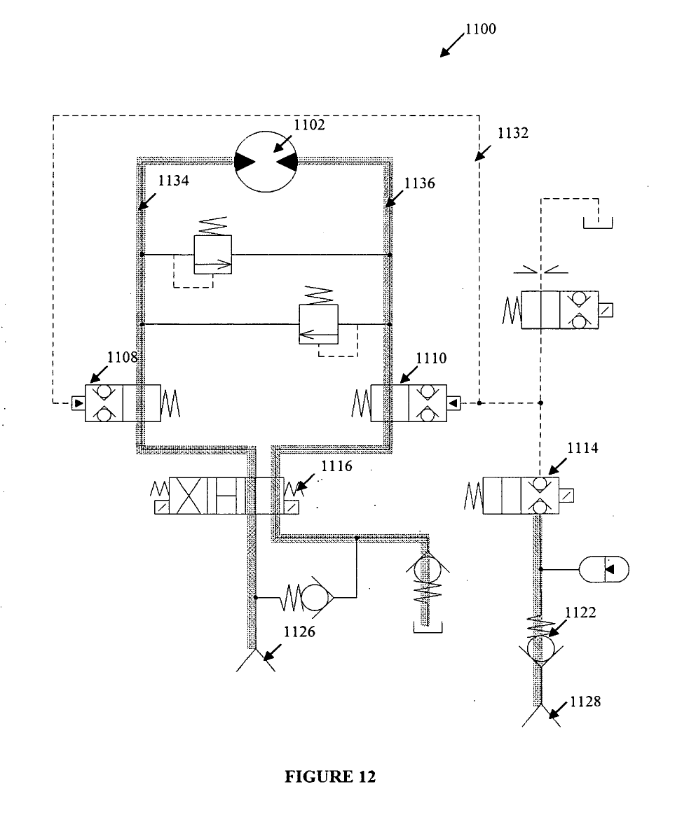

FIG. 11 relates to the yaw drive system1100 being placed in an uncontrolled mode (or a mode where no power is supplied to the entire drive system 1100). FIGS. 12 to 15 relate to different controlled operating modes when power is suppled to the yaw drive system 1100. The operation of the yaw drive system 1100 is described in more detail below.

FIG. 11 is a block diagram of the components of the yaw drive system 1100 when configured in a parked state. The yaw drive system 1100 includes a drive component 1102 (e.g. a hydraulic motor for engaging and positioning the rotor relative to the vertical rotational axis 208), pressure relieving valves 1104 and 1106, control valves 1108, 1110, 1112 and 1114, a yaw direction control valve 1116, check valves 1118, 1120 and 1122, a high pressure source 1126, a pilot source 1128 and a high pressure source 1130. The high pressure source 1126 provides pressurized hydraulic fluid for controlling the motion of the drive component 1102. The pilot source 1128 is a separate source of pressurized hydraulic fluid (referred to as a pilot signal) for controlling the configuration of the control valves 1108 and 1110 of the yaw drive system 1100.

When the yaw drive system 1100 is configured in the manner shown in FIG. 11, the pilot signal from the pilot source 1128 flows through the control valve 1114, which is configured in an open (or de-energized) position. This allows the pilot signal to flow through the control channel 1132 (shown in dotted lines in FIG. 11). Since the control valve 1112 is configured in an open (or de-energized) position, the pilot signal is able to flow through the control valve 1112 and orifice 1124 so that insufficient hydraulic pressure builds up in the control channel 1132 to activate either of the control valves 1108 and 1110. Therefore, both control valves 1108 and 1110 remain in an open (or deactivated) position. The yaw direction control valve 1116 is configured by default to a position that allows fluid from the high pressure source 1126 to flow through both the first and second drive channels 1134 and 1136. This inhibits resistance to the rotation of the drive component 1102, so that the rotor is able to rotate to any yaw position with minimal resistance.

FIG. 12 is a block diagram of the components of the yaw drive system 1100 when configured in a drive state for rotating the drive component 1102 in a first direction. In this configuration, the control valve 1114 is placed in a closed (or energized) position. The control valves 1108 and 1110 remain in the open (or deactivated) position. The yaw direction control valve 1116 is configured to a first driving position which allows fluid from the high pressure source 1126 to flow into the first drive channel 1134 and cause the drive component 1102 (and therefore the rotor) to rotate in a first direction. Fluid in the second drive channel 1136 can flow through the yaw direction control valve 1116 so as to minimize any resistance to the rotation of the drive component 1102 in the first direction.

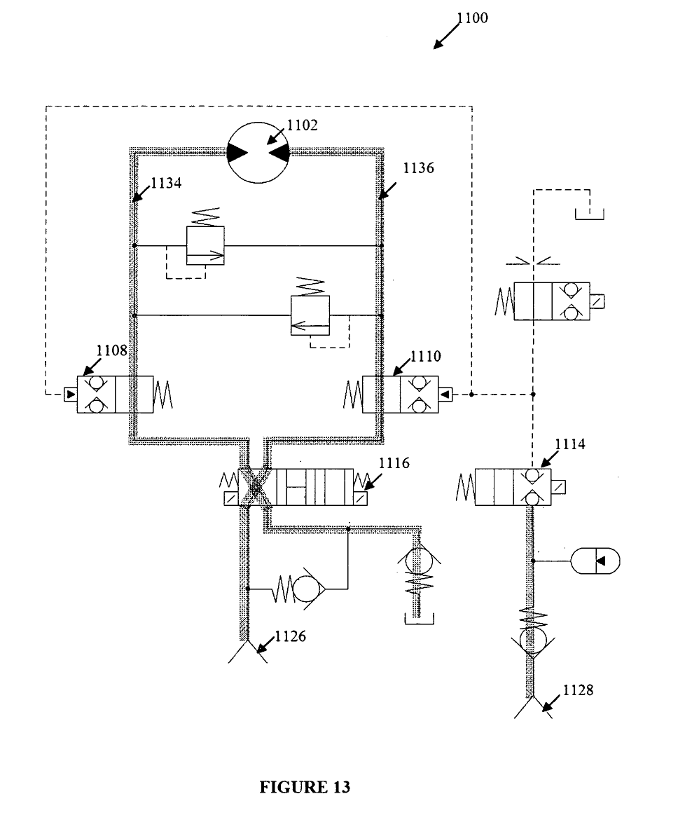

FIG. 13 is a block diagram of the components of the yaw drive system 1100 when configured in a drive state for rotating the drive component 1102 in a second direction (opposite to the first direction). In this configuration, the control valve 1114 is placed in a closed (or energized) position. The control valves 1108 and 1110 remain in the open (or deactivated) position. The yaw direction control valve 1116 is configured to a second driving position which allows fluid from the high pressure source 1126 to flow into the second drive channel 1136 and cause the drive component 1102 (and therefore the rotor) to rotate in a second direction (which is opposite to the first direction). Fluid in the first drive channel 1134 can flow through the yaw direction control valve 1116 so as to minimize any resistance to the rotation of the drive component 1102 in the second direction.

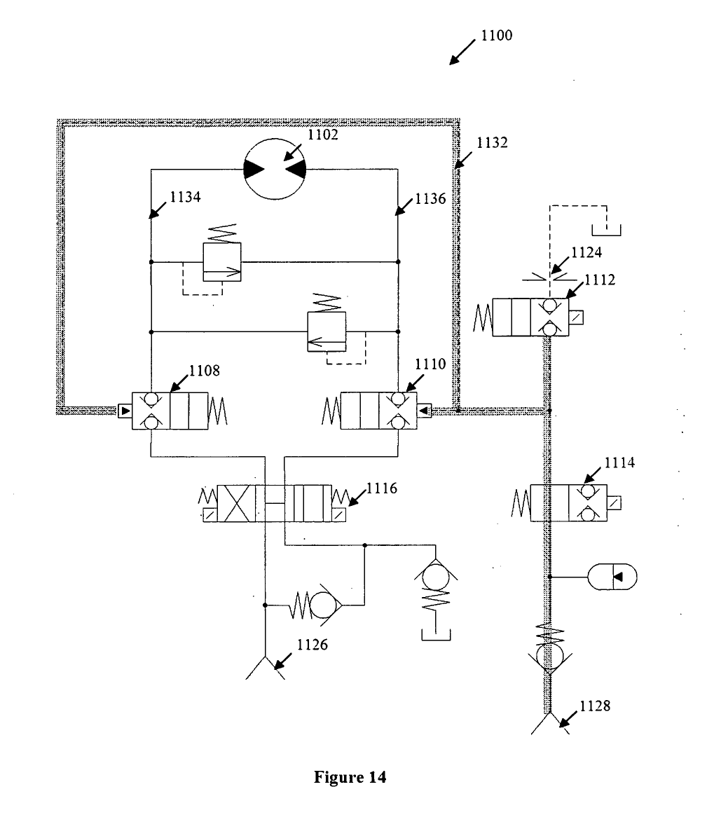

FIG. 14 is a block diagram of the components of the yaw drive system 1100 when configured in a locked state for resisting further rotation of the drive component 1102 (and the rotor). In this configuration, the control valve 1114 is placed in an open (or de-energized) position and the control valve 1112 is placed in a closed (or energized) position. Fluid from the pilot source 1128 flows through the control valve 1114 and into the control channel 1132. The closed control valve 1112 allows hydraulic pressure to build up in the control channel 1132, which activates both control valves 1108 and 1110 (i.e. configures the valves 1108 and 1110 to a closed (or activated) position). The activation of control valves 1108 and 1110 inhibits the flow of any fluid trapped in the first and second drive channels 1134 and 1136, which therefore inhibits the rotation of the drive component 1102 (and the rotor) from its current yaw position. To allow the drive component 1102 to rotate once again, control valve 1112 is placed in an open (or de-energized) position which allows the pilot signal to escape via the orifice 1124 and thus allow the control valves 1108 and 1110 to return to its default open (or deactivated) position. The configuration shown in FIG. 14 can be used to restrain the yaw motion of the rotor such as during the start-up or shut-down phase of the rotor, or when it is desirable to hold the rotor steady in a fixed yaw position (e.g. for safety reasons during maintenance).

During use, the high pressure source 1126 and 1128 may be configured to continuously supply pressurized hydraulic fluid for operating the yaw drive system 1100. However, it would be desirable (e.g. during power production) to allow the rotor of the wind turbine 100 to freely rotate to different yaw positions to face the incoming direction of the wind (with minimal resistance). According to one representative embodiment of the present invention there is provided an additional mode whereby the drive component 1102 is able to freely rotate to different yaw positions when the rotor is in a power production mode. To achieve this, the yaw drive system 1100 is configured to inhibit resistance to the rotation of the drive component 1102 (and therefore the rotor) to a different yaw position.

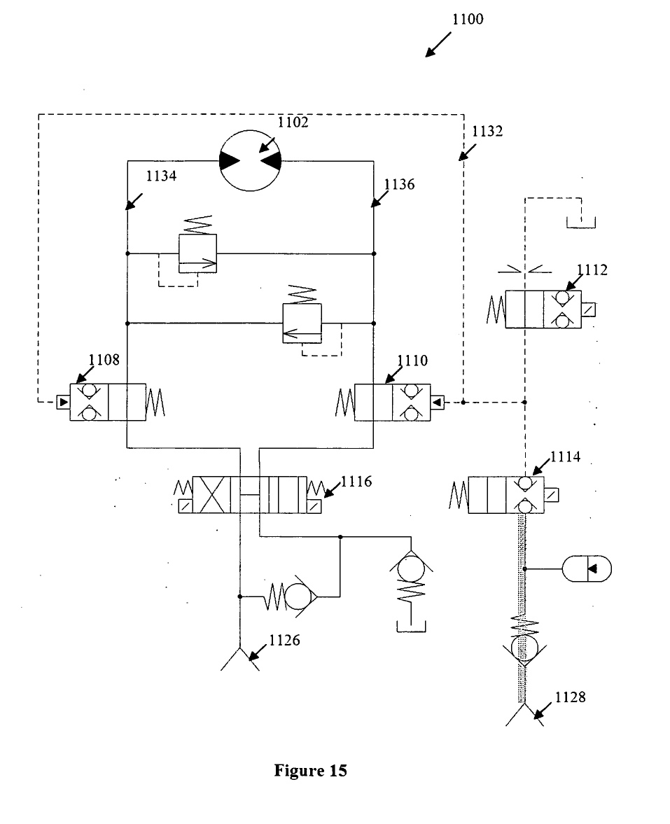

FIG. 15 shows one possible configuration for allowing the drive component 1102 (and rotor) to freely rotate to different yaw positions during power production. The control valve 1114 is placed in a closed (or energized) position and the control valve 1112 is placed in an open (or de-energized) position to minimize fluid pressure from building up in the control channel 1132. This configuration of the control valves 1108 and 1110 and the yaw direction control valve 1116 is the same as that shown in FIG. 11. This allows fluid from the high pressure source 1126 to flow between the first and second drive channels 1134 and 1136 which inhibits resistance to any rotation of the drive component 1102.

Modifications and improvements to the invention will be readily apparent to those skilled in the art. Such modifications and improvements are intended to be within the scope of this invention. For example, the representative embodiments can be applied to any rotor having more than two blades, and/or having more than one critical zone. Further, although the present specification describe a downwind turbine configuration (i.e., the rotor is placed downwind from the tower when in power production), the present invention may also be applied to a turbine with upwind configuration (i.e., the rotor is placed upwind from the tower when in power production). The algebraic sign convention employed in the figures and descriptions herein define flap angle with reference to a rotor plane and the incident wind direction when in power production. When defined in this manner the descriptions presented apply equally to downwind and upwind configuration turbines. In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned. The word ‘comprising’ and forms of the word ‘comprising’ as used in this description and in the claims does not limit the invention claimed to exclude any variants or additions.

What is claimed is:

1. A control system for a wind turbine having a plurality of blades arranged for rotation about an axis, said blades being adjustable between different incline positions relative to said axis, said control system including:
one or more position sensors for detecting the presence of any said blade at one or more different blade positions about said axis;
a flap controller for generating flap control data for adjusting an incline position of each detected said blade independently of each other; and
a blade pitch controller for detecting an incline position for each detected said blade, and selectively adjusting a pitch position of each detected said blade based on the flap control data and detected incline position for each detected said blade.

2. A system as claimed in claim 1, wherein each of the position sensors are placed at a different location about said axis, each said position sensor for detecting a different said blade position relative to said axis.

3. A system as claimed in claim 1, wherein at least one of said position sensors is placed within an approach region of said blades, said approach region being defined by a rotational path of said blades between a start position located directly above said axis, and an end position located directly below said axis.

4. A system as claimed in claim 3, wherein said flap controller generates flap control data for decreasing an incline position of a particular said blade detected by the position sensor located in said approach region.

5. A system as claimed in claim 4, wherein said blade pitch controller selectively decreases a pitch angle position of the particular blade based on the flap control data and detected incline position for that particular blade.

6. A system as claimed in claim 3, wherein at least one of said position sensors is placed with a trail region of said blades, said trail region being defined by a rotational path of said blades between a start position located directly below said axis, and an end position located directly above said axis.

7. A system as claimed in claim 6, wherein said flap controller generates flap control data for increasing an incline position of a particular said blade detected by the position sensor located in said trail region.

8. A system as claimed in claim 7, wherein said blade pitch controller selectively increases a pitch angle position of the particular blade based on the flap control data and detected incline position for that particular blade.

9. A system as claimed in claim 1, including:
a speed sensor for detecting a rotational speed of said blades;
said flap controller being configured for generating said flap control data based on at least one of:
i) said rotational speed; and
ii) a change in said rotational speed over time.

10. A system as claimed in claim 1, wherein said flap control data includes data representing one or more commands, instructions or parameters for either:
i) increasing an incline position of at least one of the blades; and
ii) decreasing an incline position of at least one of the blades.

11. A system as claimed in claim 9, wherein said flap control data includes data representing a target angle value for adjusting an incline position of at least one of the blades, the target angle value being generated based on said rotational speed.

12. A system as claimed in claim 1, wherein said blade pitch controller in use:
generates, based on said flap control data, pitch control data including data representing separate blade adjustment parameters for one or more of said blades; and
adjusts the pitch position of at least one of the blades independently of other said blades based on said pitch control data for the corresponding said blade.

13. A system as claimed in claim 12, wherein said pitch control data for a particular one of said blades includes data representing at least one of the following:
i) a pitch angle; and
ii) a pitch angle and a period of time for carrying out the pitch adjustment.

14. A system as claimed in claim 13, wherein said blade pitch controller includes a different actuator for controlling the pitch position of a different said blade.

15. A control method for a wind turbine having a plurality of blades arranged for rotation about an axis, said blades being adjustable between different incline positions relative to said axis, said method including:
detecting the presence of any said blade at one or more different blade positions about said axis;
generating flap control data for adjusting an incline position of each detected said blade independently of each other;
detecting an incline position for each detected said blade; and
selectively adjusting a pitch position of each detected said blade based on the flap control data and detected incline position for each detected said blade.

16. A wind turbine including a control system as claimed in claim 1.

17. A control system for a wind turbine having a plurality of blades arranged for rotation about an axis, said blades being adjustable between different incline positions relative to said axis, said control system including:
a speed sensor for detecting a rotational speed of said blades;
a flap controller for generating, based on the rotational speed, flap control data for adjusting the incline positions of one or more of said blades; and
a blade pitch controller for detecting the incline positions for one or more of said blades, and adjusting a pitch position of one or more of said blades independently of each other based on the flap control data and the detected incline positions of the blades.

18. A system as claimed in claim 17, wherein said flap control data is generated based on a comparison of said rotational speed with a predetermined target speed.

19. A system as claimed in claim 18, wherein said target speed represents a predetermined maximum rotational speed of said blades during power production.

20. A system as claimed in claim 18, wherein said flap control data includes data representing one or more commands, instructions or parameters for either:
i) increasing an incline position of at least one of the blades; and
ii) decreasing an incline position of at least one of the blades.

21. A system as claimed in claim 20, wherein said flap control data includes data representing a target angle value for an incline position of at least one of the blades, the target angle value being generated based on said rotational speed.

22. A system as claimed in claim 21, including generating said flap control data including data representing a greater said target angle value in response to detecting a decrease in the rotational speed of the blades.

23. A system as claimed in claim 21, including generating said flap control data including data representing a smaller said target angle value in response to detecting a decrease in the rotational speed of the blades.

24. A system as claimed in claim 20, wherein said flap control data includes data representing a target angle value for adjusting an incline position of at least one of the blades, wherein the target angle value is generated based on a change in the rotational speed over time.

25. A system as claimed in claim 18, wherein said blade pitch controller in use:
generates, based on said flap control data, pitch control data including data representing separate blade adjustment parameters for one or more of said blades; and
independently adjusts the pitch position of at least one of the blades based on said pitch control data for the corresponding said blade.

26. A system as claimed in claim 25, wherein said pitch control data for a particular one of said blades includes data representing at least one of the following:
i) a pitch angle; and
ii) a pitch angle and a period of time for carrying out the pitch adjustment.

27. A system as claimed in claim 18, wherein said blade pitch controller includes a plurality of actuators, each actuator for adjusting the pitch of a different said blade.

28. A system as claimed in claims 26, wherein each said actuator adjusts the pitch position of a different said blade to a pitch angle represented by the pitch control data.

29. A system as claimed in claims 27, wherein each said actuator adjusts the pitch position of a different said blade to a pitch angle represented by the pitch control data

30. A system as claimed in claims 26, wherein each said actuator adjusts the pitch position of a different said blade over a period of time as represented by the pitch control data.

31. A system as claimed in claims 27, wherein each said actuator adjusts the pitch position of a different said blade over a period of time as represented by the pitch control data.

32. A blade pitch control method for a wind turbine having a plurality of blades arranged for rotation about an axis, said blades being adjustable between different incline positions relative to said axis, said method including:
detecting a rotational speed of said blades;
generating, based on the rotational speed, flap control data for adjusting the incline positions of one or more of said blades;
detecting the incline positions for one or more of the blades; and
adjusting a pitch position of one or more of said blades independently of each other based on the flap control data and the detected incline positions of the blades.

33. A method as claimed in claim 32, wherein said flap control data is generated based on a comparison of said rotational speed with a predetermined target speed.

34. A method as claimed in claim 33, wherein said target speed represents a predetermined maximum rotational speed of said blades during power production.

35. A method as claimed in claim 32, wherein said flap control data includes data representing one or more commands, instructions or parameters for either:
i) increasing an incline position of at least one of the blades; and
ii) decreasing an incline position of at least one of the blades.

36. A method as claimed in claim 35, wherein said flap control data includes data representing target angle value for an incline position of at least one of the blades, the target angle value being generated based on said rotational speed.

37. A method as claimed in claim 36, including generating said flap control data including data representing a greater said target angle value in response to detecting a decrease in the rotation speed of the blades.

38. A method as claimed in claim 36, including generating said flap control data including data representing a smaller said target angle value in response to detecting a decrease in the rotation speed of the blades.

39. A method as claimed in claim 35, wherein said flap control data includes data representing a target angle value for adjusting an incline position of at least one of the blades, wherein the target angle value is generated based on a change in the rotational speed over time.

40. A method as claimed in claim 32, including the step of:
generating, based on said flap control data, pitch control data including data representing separate blade adjustment parameters for one or more of said blades; and
independently adjusting the pitch position of at least one of the blades based on said pitch control data for the corresponding said blade.

41. A method as claimed in claim 40, wherein said pitch control data for a particular one of said blades includes data representing at least one of the following:
i) a pitch angle; and
ii) a pitch angle and a duration for carrying out the pitch adjustment.

42. A method as claimed in claim 41, including adjusting the pitch position of a different said blade to a pitch angle represented by the pitch control data.

43. A method as claimed in claim 41, including adjusting the pitch position of a different said blade over a period of time as represented by the pitch control data.

44. A wind turbine including a control system as claimed in claim 18.

45. A yaw control system for a wind turbine having a rotor with a plurality of blades arranged for rotation about a rotational axis, said system including a drive component that:
i) inhibits rotational resistance of said rotor to permit movement of said rotor between different yaw positions relative to a vertical axis of said turbine;
ii) is controllable for selectively moving said rotor from a first yaw position to a second yaw position; and
iii) is controllable for releasably engaging said rotor to resist further rotation of said rotor from a predetermined yaw position.

46. A system as claimed in claim 45, wherein said blades are adjustable between different incline positions relative to said rotational axis.

47. A system as claimed in claim 45, wherein said drive component is configurable to a controlled mode and an uncontrolled mode; and
said drive component inhibiting said rotational resistance of the rotor when configured to the uncontrolled mode.

48. A system as claimed in claim 47, additionally comprising:
said drive component defaulting to said uncontrolled mode in the absence of power being communicated to the drive component.

49. A system as claimed in claim 45, additionally comprising:
a drive controller; and
said drive controller configure to cause said drive component to selectively move said rotor to different yaw positions relative to said vertical axis.

50. A system as claimed in claim 45, additionally comprising:
a drive controller; and
said drive controller causing an engagement of at least a portion of said rotor to said drive component as a means to resist a further rotation of said rotor.

51. A system as claimed in claim 45, wherein said drive component includes a hydraulic motor.
